(19) United States
(12) Patent Application Publication
(10) Pub. No.: US 2014/0196325 A1
(43) Pub. Date: Jul. 17, 2014

(54) CARD WITH AREA CONTAINING COMPONENTS CAPABLE OF MOVEMENT

(71) Applicant: HALLMARK CARDS, INCORPORATED, Kansas City, MO (US)

(72) Inventors: DOUGLAS M. BOWEN, FITCHBURG, MA (US); KARI JEAN WALBERG, OVERLAND PARK, KS (US); TSANG TO LEUNG GORDON, HONG KONG (CN); STEPHEN R. EIKOS, LENEXA, KS (US); CRAIG HUGHES, LEE'S SUMMIT, MO (US)

(73) Assignee: HALLMARK CARDS, INCORPORATED, KANSAS CITY, MO (US)

(21) Appl. No.: 13/743,120

(22) Filed: Jan. 16, 2013

(51) Int. Cl. G09F 1/04

(52) U.S. Cl. CPC G09F 1/04
USPC 40/124.09; 40/124.191; 40/124.01

(57) ABSTRACT

A card, such as a greeting card, is provided. The card includes an enclosed space that is partially embedded in or coupled to a portion of the card, where the space includes pieces of material that are moved within the space by one or more moving pieces. In embodiments, a front or a back panel of the card features an enclosure housing fan operable to disperse the pieces or particles. In some cases, the fan and other components for moving the pieces is concealed from view by a cover. In one example, a card features an enclosure with the appearance of a snow globe and includes a wheel connected to a control that allows a user to activate movement of particles inside the enclosure. In embodiments, movements may be timed to increase the interactions of the particles.

### SUMMARY

Embodiments of the invention are defined by the claims below, not this summary. A high-level overview of various aspects of the invention are provided here for that reason, to provide an overview of the disclosure, and to introduce a selection of concepts that are further described in the Detailed-Description section below. This summary is not intended to identify key features or essential features of the claimed subject matter, nor is it intended to be used as an aid in isolation to determine the scope of the claimed subject matter.

In brief and at a high level, this disclosure describes, among other things, a card, such as a greeting card, with an enclosed or separated area, which contains one or more pieces of material that can be moved, such as by a rotating element. Movement within the area of the card propels pieces of matter throughout the area. In one example, a rotating element can use blades to cause the disbursement of pieces of material intended to represent snowflakes throughout the area, where the exposed portion of the area appears round in shape and represents a snow globe. In embodiments, a viewer of a card can operate a control to cause movement of the particles throughout the area, which may occur through iterations of movement based on pulses of energy.

### DESCRIPTION OF THE DRAWINGS

Illustrative embodiments of the invention are described in detail below with reference to the attached drawing figures, and wherein:

FIG. 1 is a perspective view of a greeting card in accordance with an embodiment of the invention;

FIG. 2 is a perspective view of the greeting card of FIG. 1 in a substantially open condition;

FIG. 3 is a front elevation view of the greeting card of FIG. 1 in a substantially closed condition;

FIG. 4 is a perspective view of the greeting card of FIG. 1 with portions of a front panel and a cover cut-away for clarity;

FIG. 5 is a front elevation view of the greeting card of FIG. 3 with a portion of the front panel and the cover cut-away for clarity;

FIG. 6 is a left side cross-sectional view of the greeting card taken along the line 6-6 of FIG. 3, with a portion of the cover cut-away for clarity and an enlarged callout area;

FIG. 7 is an exploded view of portions of the greeting card of FIG. 1 illustrating various components;

FIG. 8 is an enlarged, side elevation view of a component of the greeting card of FIG. 1 capable of movement in accordance with an embodiment of the invention; and

FIG. 9 is a perspective view of a rear of the greeting card in accordance with an embodiment of the present invention illustrating the card body before the print panel is secured to an intermediate panel with a second layer therebetween.

### DETAILED DESCRIPTION

The subject matter of select embodiments of the invention is described with specificity herein to meet statutory requirements. The description itself, however, is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

In an embodiment, a greeting card includes one or more panels or segments, such a front panel and a back panel. The front side of either panel, or the back side of the front panel, includes an enclosure, and the enclosure contains particles of matter. The particles are contained by the enclosure on at least one side and, in embodiments, a layer of material on one or more sides, such that the particles are substantially within the enclosure and the particles are trapped within the enclosure. In embodiments, the enclosure surrounds the particles on all sides except for one, and the particles are surrounded on this remaining side by one or more other components of the card, such as a layer of material. The material may comprise the front or back panel, or an inside layer or second panel.

In embodiments, an enclosure included on a panel of the greeting card includes a rotating element. The rotating element, such as a wheel or fan, is capable of interacting with the particles and causing their movement. The rotating element may be mechanically and/or electrically powered in order to rotate and cause the movement of particles within the enclosure.

In an embodiment, a rotating element located partially or completely within the enclosure is connected to a power source, such as one or more batteries or other power-storage components, which can be connected to sources of mechanical, solar, or electrical power. Rotating elements can include one or more blades that extend from the rotating element. The blades, in an embodiment, extend axially from a rotating wheel-type piece, such that the blades are perpendicular to a flat-topped rotating piece. In other words, in an embodiment, a substantially flat, circular rotating piece includes rectangular blades that extend perpendicularly away from the rotating piece. The blades can be arranged at regular intervals to each other, and the blades can be substantially flat and rectangular in shape.

In another embodiment, a rotating element may be coupled to a power source through one or more connections, such as wire(s) or other conducting materials, in order to cause rotation. A rotating element, including one or more blades, can be located a particular distance or space from an edge of the enclosure on one or more sides. For example, an embodiment can include a particular margin of space, such as 0.25 inches to 0.5 inches, on two or three sides of a rotating element (in addition to the space above the rotating element and within an enclosure).

Embodiments of the invention include a front panel or segment of a card where the front panel includes layers of material, such as two or three layers of material, for example cardstock. An enclosure, such as a plastic “bubble” type enclosure with one open side, can be partially embedded underneath one or more layers. In embodiments, the embedded portion of an enclosure is the edge or rim of the enclosure, so that an outer layer of cardstock covers the flattened edges of the enclosure that are affixed to an inner layer.

In embodiments, a portion of the enclosure that contains moving elements or mechanical pieces, or elements with functional purposes only, can be covered by a layer of material. A cover can be provided by an integral extension of a first layer, which can extend out from the panel and cover a portion of an enclosure and/or the moving parts within the enclosure. In other embodiments, a first layer covers the edges of the enclosure while a cover extends to substantially conceal moving or other functional elements. A first or top layer and a cover can be integral with the rest of the panel or separately composed and/or affixed to the panel.

In a further embodiment, a note or card has one or more segments, and each segment has a front and back side. The segments are substantially flat or two-sided. A front side of either segment can include an encapsulated area, and the encapsulated area includes a rotating piece. The rotating piece is located in between two or more sides of the encapsulated area, such that the encapsulated area includes multiple sides, which may be transparent, and it can include one or more opaque sides provided by a different material. In an embodiment, an encapsulated area is created by multiple edges of a clear material, such a plastic dome or multi-sided shape, which has been affixed to another material, providing one side of another material (or another side of the same material, but where the side, such as the backside of the encapsulated area, is affixed instead of integrally-connected).

Embodiments include a rotating component substantially within the encapsulated area. In an example, a wheel that is capable of rotation is located within a plastic encapsulated area that includes a cardstock backside (which is affixed to the plastic). In embodiments, this allows a theme, design, or photograph, for example, to be visible through the encapsulated area and behind the trapped particles or pieces of matter within the encapsulated area. A rotating component can be placed at specific distances from the edges of the encapsulated area that are substantially perpendicular to the front side of the card. For example, a varying amount of space can be provided around a rotating piece to allow for particles to pass between the rotating piece and the sides of the encapsulated area.

In embodiments, pieces of matter, such as paper or plastic pieces of matter, can be included within the encapsulated area, and a rotating component can be connected to (and controlled from) an external button or trigger. An encapsulated area includes a bulged portion, in an embodiment, where the bulged portion surrounds the top of a rotating piece. A cover or first layer on the front side of a panel can conceal the bulged portion, in order to present a partial encapsulated area to a viewer of the card, which may be a more preferred shape and/or conceal purely functional components. The rotating component may operate with pulses, where pressing or activating a control causes more than one pulse of energy from a power source to cause more than one force to act on the rotating component, for example multiple bursts of rotation at timed or irregular intervals.

A further embodiment includes a note that has a sealed space displayed on a front or inside panel. The space may be sealed to the extent that it contains particles, such as simulated snowfall, without being completely sealed to air or other elements. The note can be a greeting card, and the theme or message of the sealed space can correspond to a front layer of material on a note, and to a second layer of material within a note that is exposed by a translucent sealed space (which also fits into a cut-out space in the front layer). In an embodiment shown, a front layer of material provides a holiday message, a cover conceals mechanical components in the sealed space and is consistent with the holiday message, and instructions are provided for controlling the mechanical components (e.g., “Press Here”).

In an embodiment, the mechanical components can be electrically powered and located within the sealed space. In embodiments, a portion of the mechanical components are within the sealed space while another portion are located outside of the sealed space, and a connection is required to deliver power from a source to a mechanically-rotating component. In some embodiments, circuitry is provided inside or outside of the sealed space to generate pulses or bursts of energy at specific intervals, as discussed below.

The pulses or bursts of mechanical energy can be used to rotate or spin a wheel-type device, which includes blades that interact with small particles of matter within the enclosed space. In an embodiment, the blades are parallel to an axis that runs through the approximate center of the rotating component, and pieces of matter are propelled by the blades. A certain amount of space can exist between the blade and/or the top of the rotating piece and the top edge of an enclosure, in embodiments. The rotating piece can be substantially concealed to a viewer by an outer layer of material, such as a cover.

As described more fully below, a raised or rounded space on the front of a card panel can include a partially elongated or angular shape on one end, such that an exposed portion of the space appears to be round or appears to have the remainder of a spherical shape concealed. A rounded corner of particular angles at one end of the space can provide a shape that enables or enhances the disbursement of particles throughout the space during use of a rotating piece. A minimum amount of distance can be provided within a space to provide room around a rotating piece and the blades, and the amount of distance can vary around the edges of the rotating piece. The distance can be configured to provide more interaction between particles and/or to increase the amount of particles viewed in an exposed portion of the space.

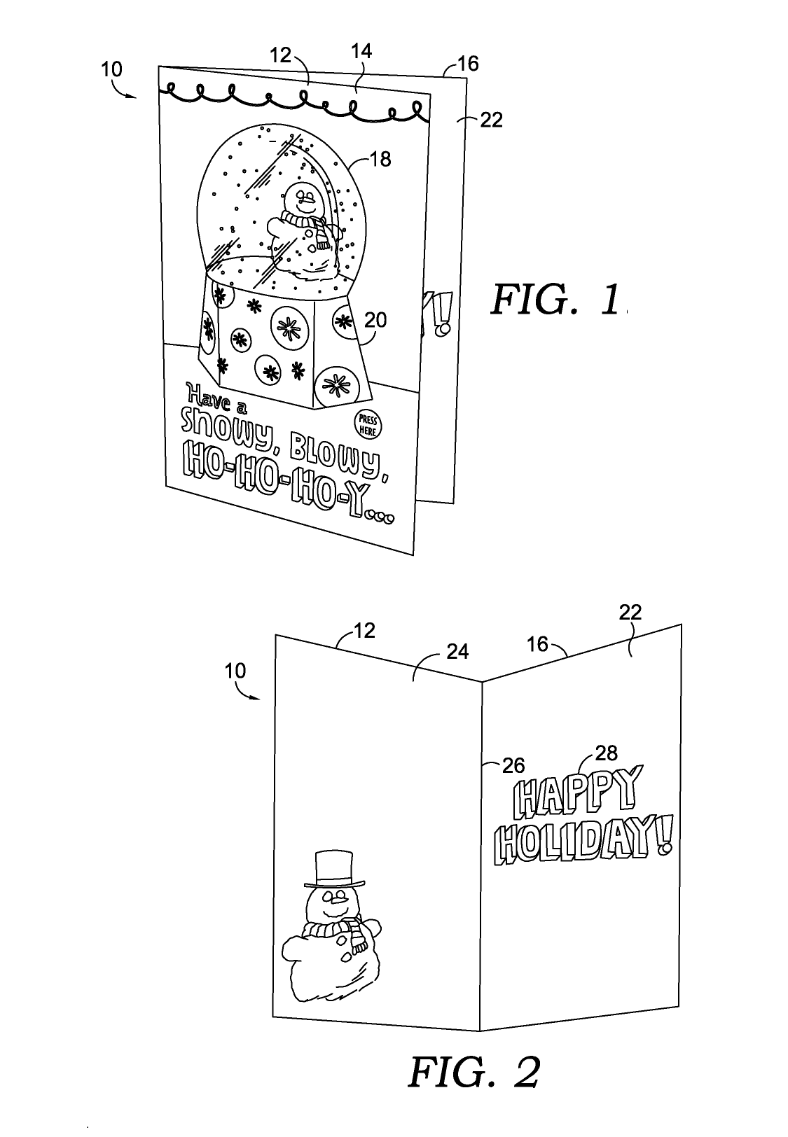

Referring initially to FIG. 1, a card 10 is shown, such as a greeting card. The card 10 can be made with or based on any suitable material, and the card 10 can be adorned or decorated with additional materials, such as paper, cardboard, cardstock, plastic, and metallic materials. In embodiments, the card 10 can be intended for receipt by a specific person or set of people, such as through delivery using a postal service, through the use of an envelope or not (such as a postcard), or hand-delivery. The card 10 can include or be a note of expression or sentiment, or a notification of an act or event.

FIG. 1 illustrates a perspective view of a card in accordance with an embodiment of the invention. As shown in FIG. 1, the card 10 is in a slightly open condition. A generally planar front panel 12 or segment of the card 10 has a front layer or surface 14. The card 10 also has a generally planar rear panel 16. Front panel 12 and rear panel 16 are shown in a substantially rectangular shape, but the panels or segments of the card 10 can be any shape.

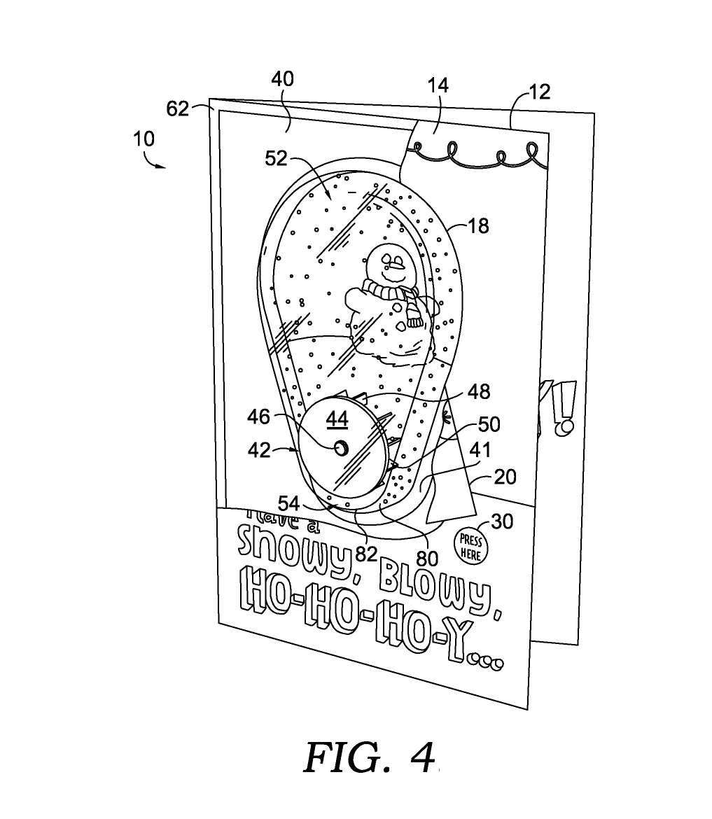

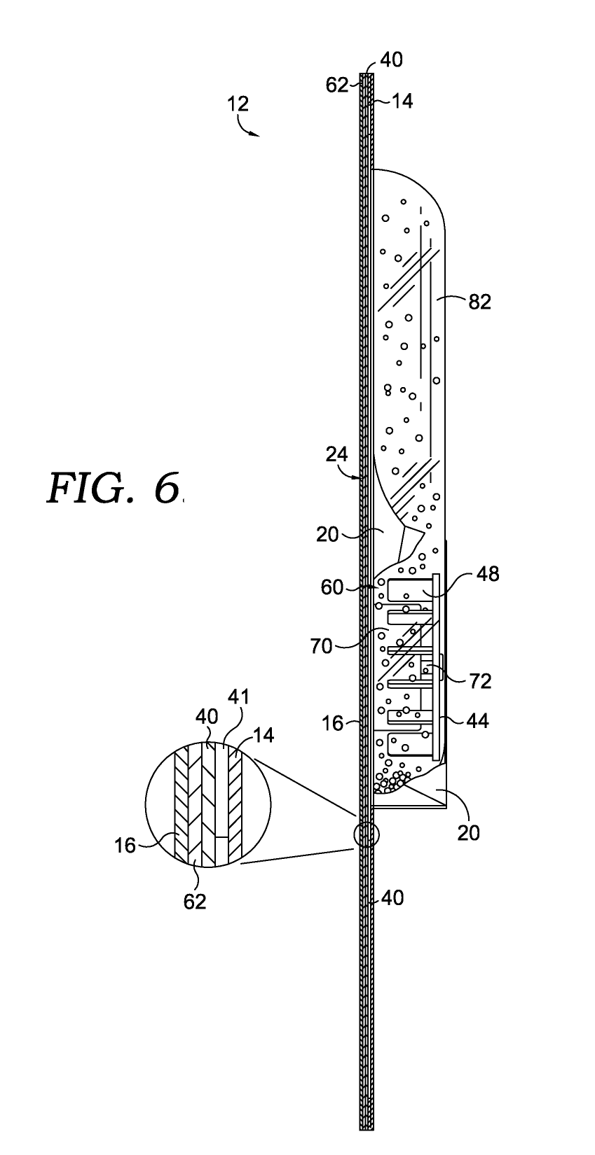

The embodiment in FIG. 1 illustrates the card 10 with an enclosure 18 visible on or through the front layer 14 of card 10. The cover 20 is shown near the lower portion of the enclosure 18 and, in an embodiment, the cover 20 is located partially over or in front of the enclosure 18. The cover 20 can be part of the front layer 14 or a separate piece, as discussed below. In an embodiment, the enclosure 18 is coupled to the front surface 14 of the card 10. In other embodiments, the enclosure 18 is affixed to a second layer, described with respect to FIGS. 4 and 6, below.

In some cases, the cover 20 can obstruct the view of a portion of the enclosure 18. Part or all of the cover 20 can affect the appearance of the enclosure 18, for example, by obscuring an elongated or curved portion of an enclosure, such that the enclosure 18 appears rounder or more circular in shape. In embodiments, the cover 20 can conceal a portion of the enclosure 18 in order to leave another shape, such as a square or heart shape, exposed on the front panel 12 of the card 10. The cover 20, in embodiments, substantially conceals internal components, discussed below, that can be used to cause movement within a space or the enclosure 18.

The rear panel 16 of the card 10 includes a front side 22, which abuts a rear side 24 of the front panel 12 of the card 10 when the card 10 is in a substantially closed condition. The front side 22 of the rear panel 16 faces substantially the same direction as the front layer 14 (towards a holder of the card 10) when the card 10 is in a substantially closed position, in embodiments of the invention.

The space or enclosure 18 is formed by a curved or sided piece or connected pieces of a non-opaque material on at least one side, in embodiments. For example, a portion of enclosure 18 facing a viewer of card 10 can be non-opaque while other portions of enclosure 18 are opaque and/or composed of a different material. In an embodiment, an enclosure 18 is plastic and rounded and affixed to a layer (such as front layer 14) of a panel (such as front panel 12), where the layer provides at least one side or portion of enclosure 18.

In embodiments, the enclosure 18 can be completely translucent and sealed as an enclosed area prior to coupling the enclosure 18 to card 10. Other materials, such as paper, compounds, plastics of any type, or other metallic or translucent materials, can provide one or more portions of enclosure 18, including a photograph or screen. The enclosure 18 can be an air-tight area or completely sealed space, by being produced of plastic or other formed materials, or the enclosure 18 can be a sealed space to the extent necessary for components and/or pieces of material to be contained therein, as discussed below. Plugs, or sealing components, can be used in conjunction with the elements described herein, in order to assist with sealing a space. In embodiments, components that connect to or within the enclosure 18 can be used or configured to obstruct or seal one or more openings of the enclosure 18.

FIG. 2 shows a perspective view of the greeting card 10 in an open condition. The front panel 12 has a back side 24, which meets the rear panel 16 along a crease or fold 26. When the card 10 is in a closed position, or a partially closed position as shown in FIG. 1, the back side 24 of the front panel 12 is facing the front side 22 of the rear panel 16. The back side 24 of the front panel 12 can simply be the rear surface of the front panel 12 or can be a back layer of another panel secured to the front panel 12, as described below, where the front layer 14 is coupled with one or more additional layers to form the front panel 12 (with the additional layer visible as back side 24 of front panel 12).

As shown in FIG. 2, an embodiment of the invention can include a message 28 on the front side 22 of the rear panel 16. The message 28 could include any type of greeting, graphic, or expression, or may include a gift, such as a gift card or cash holder. The back side 24 of the front panel 12 can also, or instead, include a message 28 intended for a viewer of card 10. The material comprising card 10 or an area on card 10 can preferably receive written or other ink-based messages, such as personalized greetings, for example, “Happy Holidays,” or “Happy Holidays, from the Smiths.” Message 28 can be added by an individual in embodiments. Messages can include writing, printing, or other printed text or graphics, photographs, or one or more containers for money, gift cards, jewelry, tokens, or other items capable of placement inside card 10.

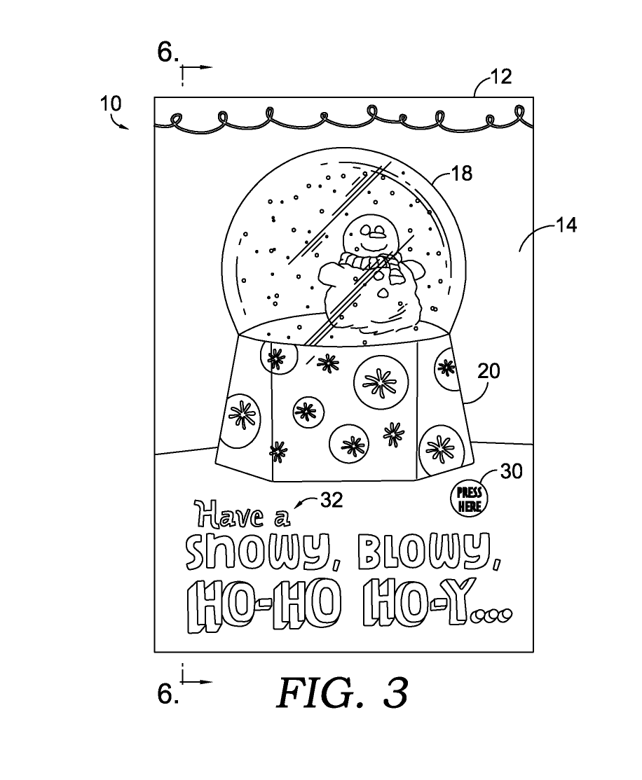

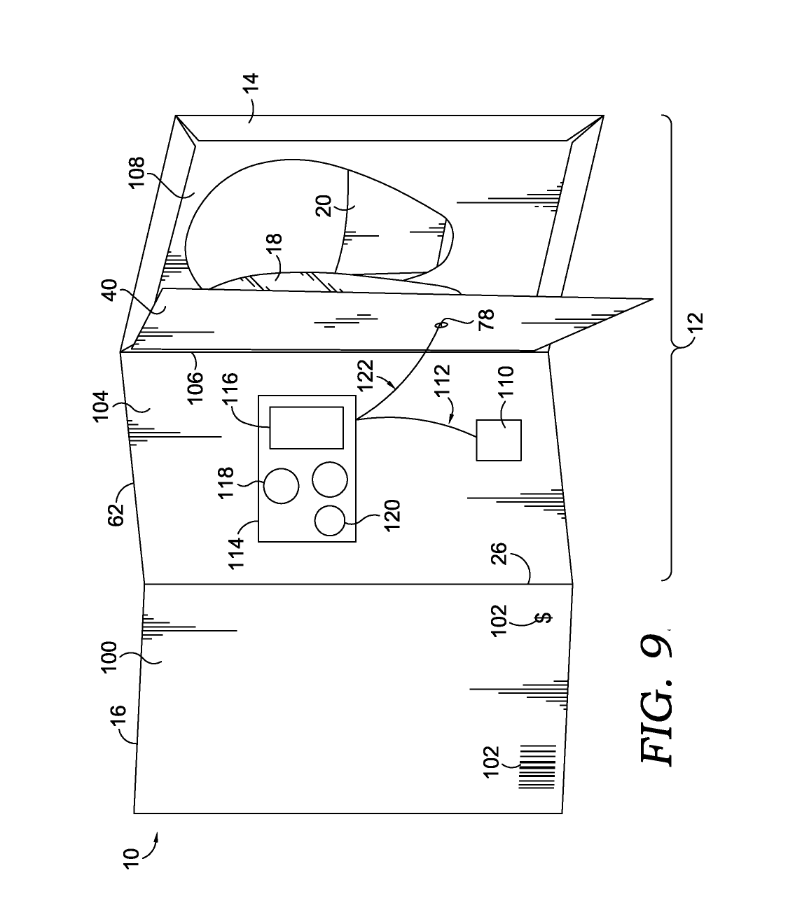

FIG. 3 illustrates an elevational view of the front of the card 10 in accordance with an embodiment. The card 10 in FIG. 3 is shown in a closed position. A control 30, such as a button, marker, graphic, or an indication of instructions, is shown in FIG. 3. The control 30 can be connected to other components, discussed below, and used to cause or trigger movement visible within enclosure 18. In embodiments, the control 30 appears to a viewer on a front layer 14, but other aspects used to control or trigger movement are located behind the front layer 14 and can be activated by the control 30, as discussed below with respect to FIG. 9. A viewer of the card 10 can interact with the control 30 to cause moving parts, described below, to be activated. In an embodiment, the control 30 includes or comprises the statement “Press Here.” Embodiments include a card 10 where no control 30 is required, and where other triggers may exist (related to light, movement, etc., such as opening or shaking the card 10).

A greeting 32 is included on the front layer 14 of the front panel 12 in an embodiment. The greeting 32 can be a textual message, a graphic message, an image and/or picture, including a cartoon, or a space for a future or personalized greeting, such as a note or photograph. The greeting 32 can coordinate with a theme that also relates to the enclosure 18, the front layer 14, and/or the cover 20.

FIG. 4 shows a perspective view of the card 10 with a portion of the front layer 14 and the cover 20 cut-away to reveal a second layer 40. In this exemplary embodiment, the second layer 40 exists behind the front layer 14 of the front panel 12. For example, the second layer 40 can also be the back side of a second or intermediate panel, such as back side 24 in FIG. 2. Other embodiments include additional layers, such that second layer 40 is stacked or sandwiched between one or more layers on each flat side, as discussed below.

As shown in FIG. 4, the enclosure 18 can have an edge or rim 41. In an embodiment, the edge or rim 41 is flush with and adhered to the second layer 40, such that no air is between the rim 41 and the second layer 40. In an embodiment, the rim 41 is composed of plastic or another molded material. The rim 41 can extend directly from the enclosure 18 and the rim 41 can be comprised of the same material, or a different material, than the enclosure 18. In embodiments, the enclosure 18 and rim 41 are integrally formed together from an extruded sheet of plastic during a vacuum forming process known as vacform, to create, in essence, a clear, plastic cup with a flat rim 41.

In embodiments, the enclosure 18 is coupled or affixed to the second layer 40 using adhesive, affixing components, or interlocking pieces, such as tabs and slits. In embodiments, the second layer 40 is visible through the enclosure 18, which can be based on the non-opaqueness of at least a portion of the enclosure 18. In embodiments, portions of the front layer 14, the second layer 40 and/or part of the enclosure 18 can be transparent for purposes of displaying a photograph or other item behind the enclosure 18 or elsewhere on the card 10.

The front layer 14 can allow space for the enclosure 18 to be viewed through and/or raised through, depending on the shape of the enclosure 18, such as spherical or rounded. In an example, a translucent enclosure 18 appears spherical due to a cover 20 and a second layer 40, and the back of translucent enclosure 18 can display graphic (e.g., a snowman and additional graphics) through the enclosure 18. In embodiments, a portion of the enclosure 18 is provided by the front layer 14 or the second layer 40, including embodiments where text, graphics, or photos are displayed inside of the enclosure 18 and on a layer. A back layer, such as a solid back layer also used to conceal components, is discussed below and can be used as a back layer with the front layer 14 and/or the second layer 40, in embodiments. In some cases, the front layer 14 can be folded over at certain edges (or all three exposed edges of front panel 12 of card 10) for improved aesthetic or tactile presentation, such as an improved smoothness or roundness to edges.

The cover 20 can extend from the front layer 14, or from the second layer 40, as a separate layer, and/or interact with slits or openings in one or more layers (not shown) to “pop-out” of front panel 12. In embodiments, the cover 20 is generated through one or more creases in the front layer 14 to create an integrally-connected cover 20, or by being a separate piece affixed or connected to the front layer 14 or the enclosure 18.

The card 10, as shown in the embodiment in FIG. 4, includes a rotating piece 42. The rotating piece 42 is substantially circular in shape with a planar top 44, according to an embodiment. In embodiments, the moving element or component partially rotates, turns or moves in one direction, or includes rotation of one element that triggers another type of motion. The rotating piece 42 can be various shapes that allow rotation, where an approximate center can be identified for rotation around. The top 44 of the rotating piece can be substantially flat, as shown in FIG. 4, or it can be raised in areas, curved, or otherwise weighted or decorated in embodiments, as described below. In embodiments, the rotating piece 42 is a wheel or fan-shaped component, and the top 44 of rotating piece 42 can be solid or include openings.

The rotating element or piece 42 may include a cap 46, as shown in FIG. 4, which can connect to other components in order to secure and/or facilitate rotation of the rotating piece 42. In embodiments, the rotating piece 42 is mechanically turned or rotated by one or more other elements, discussed below, and one or more of these elements may interact or fit with the cap 46. In an embodiment, the cap 46 is a hole or raised portion located substantially in the center of the top 44 of the rotating piece 42. In embodiments where the shape of rotating the piece 42 does not have a substantial center, or where the shape or other weight or performance issues, the placement of the cap 46 (and corresponding components used to cause rotation) can be located elsewhere on the rotating piece 42. The top 44 can include other slits, holes, or openings for purposes such as allowing air, particles, or other matter to pass (not shown).

The rotating component or piece 42 can comprise a fan, wheel, or other component that can be coupled to other components in order to move, as discussed below. The rotating piece 42 can be made of plastic, metal, or other material, or a combination of materials, and the shape of rotating piece 42 can be configured to move within the shape or confines of a sealed space, such as the enclosure 18. In embodiments, the rotating piece 42 spins in one direction based on mechanical forces, discussed below. In embodiments, moving components such as the rotating piece 42 can rotate or otherwise move through manual spinning, activation, or vibrations.

Continuing with a description of the exemplary embodiment in FIG. 4, blades 48 and 50 are shown. One or more blades, such as blades 48 and 50, can be used in embodiments, such that a moving element (e.g., rotating piece 42) interacts with particles 52 of material, discussed below. The blades 48 and 50, and additional blades spaced at intervals around the edge or circumference of a moving element, can be integral with the rotating piece 42 or affixed to the rotating piece 42.

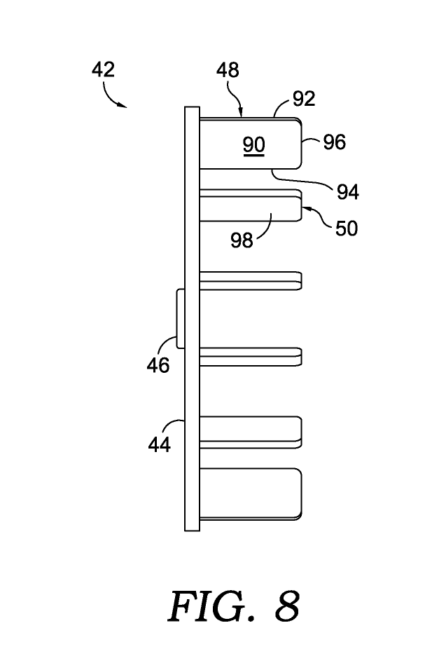

In embodiments, the blades 48, 50 can be moved in response to activation of the control 30 and/or in response to movement of a rotating mechanism or the piece 42. The propellers or blades 48, 50 can be substantially rectangular and three-dimensional in shape, as discussed with respect to FIG. 8, below, or aspects of the blades 48, 50 can be substantially oval, oblong, triangular, pedal-shaped, or other shapes. As shown in FIG. 4, a space 54 can be provided within a sealed enclosure 18, where space 54 is a space between an edge or wall 82 of an enclosure 18 and an edge of a moving component, such as rotating piece 42.

In embodiments, a certain amount of space 54 separates a moving element from an edge or wall 82 of the enclosure 18, and the amount of space 54 can vary around the circumference of the moving element, including varying by increasing towards the top of enclosure 18 and decreasing or narrowing at a bottom of the enclosure 18 (such as at end 80, discussed below). The space 54 can vary according to a function or ratio, dependent on a location around the wall 82, in order to slope or change the space 54 around rotating the piece 42, which can enable more movement or flow of the particles 52 to increase or decrease a number of collisions or interactions of the particles 52.

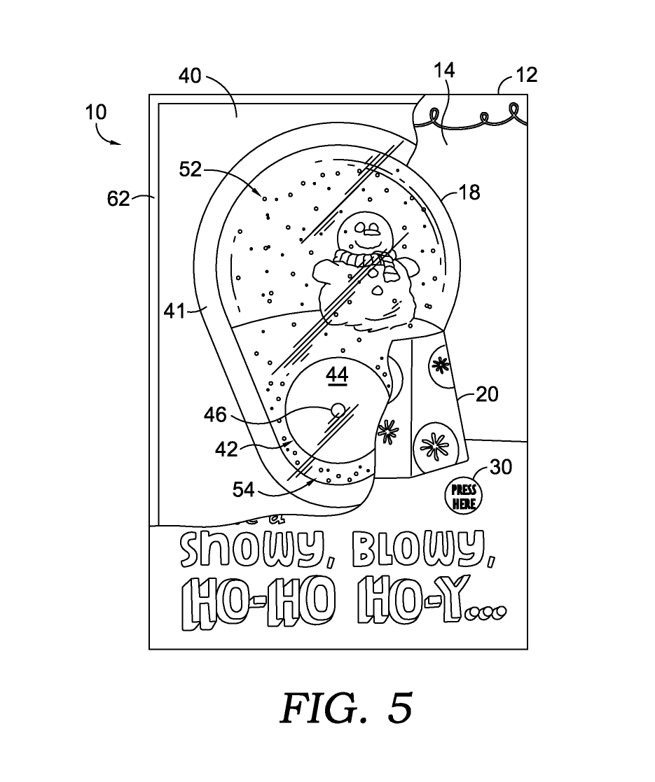

Turning to FIG. 5, an elevational view of the front segment or panel 12 of the card 10 is shown, with the card 10 in a closed condition. As shown in the embodiment in FIG. 5, the front layer 14 is partially cut-away to expose the second layer 40 and to expose the rim 41 of the sealed space or enclosure 18, which can be located in between the front layer 14 and the second layer 40. The enclosure 18 is an encapsulated area or bubble, in some cases through an entirely-encapsulated component or a partially-encapsulated area affixed to a front layer 14 or a second layer 40, such that a portion of enclosure 18 is provided by a layer. Sealing or affixing the enclosure 18 to the front layer 14 or the second layer 40, such as with adhesive or interacting components, can cause encapsulation or the trapping of the particles 52. The enclosure 18 can seal in particles, air, or other substances, such as, in some instances, even liquids or gels. In embodiments, the enclosure 18 is embedded or partially embedded in a front panel 12, partially between layers 14 and 40, as shown in FIG. 5. In embodiments, the enclosure 18 is displayed on the front side 22 of the rear panel 16, so a user views an enclosure 18 when card 10 is in an open condition, or on additional panels or segments that may be included in card 10.

FIG. 6 shows a cross-sectional view of the exemplary embodiment of the card taken along the line 6-6 of FIG. 3. While in embodiments, any panel or segment of a greeting card or packaging can include or support an enclosed space or area, such as the enclosure 18, as illustrated in FIG. 6, the front layer 14 faces outward (towards a viewer of card 10 when it is substantially closed), as does the enclosure 18. Second layer 40 is behind or to the rear of front layer 14. As described above, the edge or rim 41 of the sealed enclosure 18 can be in between two layers, such as front layer 14 and second layer 40, and the rim 41 can be affixed or sealed to any layer, such as to the second layer 40. The second layer 40 is visible through spaces in first layer 14, in embodiments, and/or through transparent portions of the enclosure 18.

FIG. 6 shows a space 60 between the blade 48 and the front layer 14. The space 60 can vary depending on the size and type of the particles 52 or the blades, such as blade 48. In embodiments, the space 60 can be essentially non-existent, such that the particles 52 cannot fit in between the blade 48 and the second layer 40 (or the front layer 14, if the enclosure 18 is affixed to or part of the front layer 14). In some cases, the space 60 provides enough room for at least two particles 52 (or more) to pass each other at their maximum width in space 60, which can maintain a more effective or appealing flow of particles 52.

In embodiments, the size of the blade 48 and/or the speed of any movement can be related to the size, mass, or other properties of the particles 52. The blade 48 and/or the rotating piece 42 (and/or spaces 60 and 54) can be intended or optimized to disperse particles 52, or to maximize the interaction or collisions of pieces of matter or particles 52, or both, in embodiments. The sizes of the spaces, such as space 60 in FIG. 6 and space 54 in FIG. 4, can be proportional to the sizes, mass, or material properties of the particles 52.

In the embodiment illustrated in FIG. 6, the back side 24 of the front panel 12, is comprised of an intermediate panel or back layer 62. The back layer 62 can be a solid layer that is viewed by a reader when the card 10 is in an open condition (as back side 24 as shown in FIG. 2). In embodiments, the back layer 62 is not used and is instead provided for by the front layer 14 or the second layer 40, or one or more layers can be integral with each other. The back layer 62 can function as a rear of the front panel 12, in the exemplary embodiment shown, and be behind both the front layer 14 and the second layer 40 from the perspective of a viewer of the front panel 12 when card 10 is substantially closed. The back layer 62 provides visual concealment and/or a smooth, decorated surface that can obstruct a view of electrical and/or mechanical components, discussed below, which can be used to connect the control 30 and other components used for movement within the front panel 12, in embodiments.

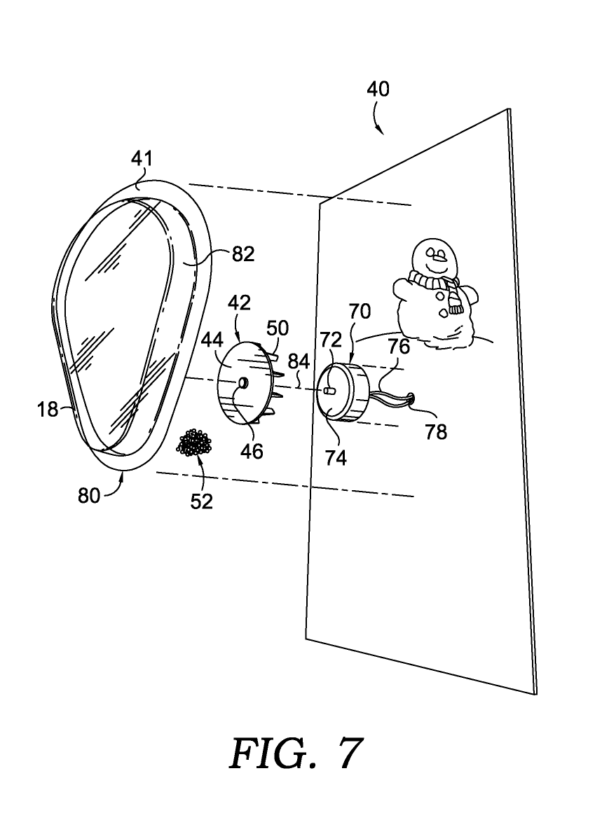

Turning now to FIG. 7, an exploded diagram illustrates components consistent with an embodiment of the invention. FIG. 7 shows an exemplary layer, such as second layer 40, which can provide a backing for the enclosure 18 upon assembly, coupling, or affixing of the enclosure 18 to the layer 40. In embodiments, the enclosure 18 is an already-sealed space that is affixed to a layer of the card 10, while other embodiments include the enclosure 18 being sealed by virtue of attachment to other portions of card 10, such as to the second layer 40.

As shown in FIG. 7, the second layer 40 can provide a background for the transparent space of the enclosure 18. In embodiments, the second layer 40 can be covered by a first layer (e.g., front layer 14) in all areas except for behind the enclosure 18. In other words, a viewer of a front panel 12 of the card 10 could view the front layer 14 and the cover 20 except, behind a clear bubble or enclosure 18, the viewer could see the second layer 40. As described below, another layer (such as back layer 62) can be behind the second layer 40, such that the back side 24 of front panel 12 substantially consists of the intermediate panel or back layer 62. In other embodiments, the second layer 40 can be the back or only layer of the front panel 12, with or without other material used to conceal the components of the card 10, such as stickers, cardstock, or other coverings.

The embodiment illustrated in FIG. 7 shows a motor 70, which can be any device that causes or generates mechanical movement based on energy. Electrical energy is received by the motor 70 and converted in order to rotate an axle 72. In embodiments, motor 70 causes rotation of axle 72 based on a current or power source, discussed below. As shown in FIG. 7, the axle 72 can extend directly from the motor 70 or the axle 72 can otherwise be connected to the motor 70. Other types of moving parts can be directly or indirectly connected to other parts to facilitate the turning of an axle 72. In embodiments, a portion 74 of motor 70, can include a power source or other circuitry and/or components in order to cause movement without the use of a separate power source, described below.

FIG. 7 illustrates an embodiment where the motor 70 can receive energy through a connection 76. The connection 76 can receive power, transmissions or communications from sources, discussed below, including sources that are also connected to the control 30 on the front panel 12 of the card 10. In an embodiment, the connection 76 is received through an opening 78, in order to connect the motor 70 with components in other layers or locations within the card 10. One or more wires or conductive components can provide the connection 76, such as electrical wires to deliver power to motor 70, which can use the power to turn the axle 72, in one example.

In embodiments, the motor 70 is an electric motor, and the motor 70 can be designed to fit inside a rotating piece 42 for space reasons, such as a desired low profile of the card 10 and/or to eliminate areas where particles 52 might collect, behave erratically, or as not intended. In embodiments, the motor 70 receives mechanical energy from manual activity, such as opening card 10, in order to cause movement of parts inside the enclosure 18, such as the axle 72.

The motor 70 can cause a direct push or pull motion, instead of rotation, in order to activate or cause movement of particles 52, either directly or indirectly. In embodiments that may include other triggers or mechanical methods for generating movement, such as pulling, winding, releasing, etc., the motor 70 may not be used or required. For example, mechanical energy can be generated by mechanical motion of a viewer of card 10 through an external component, such as a lever or pull device, or energy can be previously stored within or coupled to card 10 through other means. In embodiments, another manually-operated or motorized device besides the motor 70 is used to cause movement of particles 52 within the enclosure 18 (embedded in the card 10), such as a fan, a push mechanism, a pulse of air, or some other way of dispersing one or more particles 52 inside the enclosure 18.

Embodiments include a card 10 where the axle 72 moves and causes movement of a wheel- or fan-shaped element, such as the rotating piece 42. In exemplary embodiments, the axle 72 causes blades, such as blades 48 and 50, to contact multiple particles 52 through multiple cycles of the rotating piece 42. Cycles can be provided by pulses of energy that are provided to the motor 70 through the connection 76, as described below. In some cases only, one blade 48 is provided and the rotating piece 42 is intended to strike or move one or more pieces or particles 52 a limited amount of times, such as once at a time.

As shown in FIG. 7, embodiments include a moving element, such as the rotating piece 42, with an integral or affixed cap 46, which can secure or connect with the axle 72. The cap 46 can be an indentation or recession or opening and it can receive a component, such as the axle 72, in a secure manner so as to interlock and move in conjunction with the axle 72, which in turn can move or rotate the wheel 42. The axle 72 and cap 46 can be made certain sizes, along with other components, in order to ensure that the blades 48, 50 remain a particular height or distance from the second layer 40 (or any layer that enclosure 18 is coupled with, as illustrated in FIG. 7). In embodiments, the opening or cap 46 provides a space for insertion of a component that causes or facilitates movement of other parts.

The card 10 includes one or more panels, such as front panel 12, that feature a space or compartment, such as the enclosure 18. In embodiments discussed herein, the enclosure 18 is affixed to a second layer 40, as shown in FIG. 7, and another layer (the front layer 14) is added or included on top of the second layer 40, from the perspective of a viewer of the front of the card 10 in a substantially closed condition. As shown in FIG. 7, an edge or wall 82 of the enclosure 18 can shape or form the enclosure 18 and the design or spacing of the wall 82 with respect to moving elements, such as rotating piece 42, can dictate or affect the behavior of particles 52 during movement.

In embodiments, the enclosure 18 can be irregularly-shaped, such that a portion is elongated or bulging with respect to a symmetrical shape. For example, the end 80 of enclosure 18 is elongated and/or more angular than other sides or aspects of the enclosure 18. An elongated or asymmetrical end 80 can accommodate moving components, such as the rotating piece 42, in embodiments, and the end 80 can be the portion of the enclosure 18 that is concealed by the cover 20. In embodiments, the end 80 is hidden from view by the cover 20, and the remaining space or the enclosure 18 that can be viewed appears to be more. In embodiments, the space 18 is not symmetrical, even in conjunction with the cover 20, but the effect of the cover 20 leads a viewer to imagine that the complete enclosure 18 is a particular geometric shape, symmetrical shape, or otherwise recognizable shape (an object, cartoon character, or other image).

The card 10 can be assembled or prepared in some cases, in part, by stacking or inserting the components shown in FIG. 7 along an axis 84, such that the motor 70, the rotating piece 42, and the particles 52 are all contained within the enclosure 18. The motor 70 or other components (and/or sealing material provided behind the second layer 40) can be used with the second layer 40 to provide a portion or wall of the enclosure 18 when assembled. The rim 41 of the enclosure 18 can be placed flush with second layer 40 and attached, such as with glue or fasteners.

Turning now to FIG. 8, an enlarged view of an embodiment of the moving component or element 42 is illustrated. The moving component, such as the rotating piece 42, can be any shape, such as square, round, or decoratively-shaped. In embodiments, the rotating piece 42 moves or turns in one direction, such as clockwise or counterclockwise, with respect to an approximate center. This rotation can be clockwise or counterclockwise in a plane that is perpendicular to the plane of view in FIG. 8, such that rotating piece 42 would appear to rotate clockwise or counterclockwise when a viewer is looking directly at flat the top 44.

In embodiments, the rotating piece 42 has blades 48 and 50, and additional blades as shown in FIG. 8, up to any amount of blades in any spacing or arrangement, including formed integrally with the rotating piece 42. The blades 48 and 50 can be substantially rectangular, in embodiments, or other shapes, such as rounded or fan-shaped. Blade 48 will be discussed with respect to parts of blades 48 and 50 and other exemplary blades shown in FIG. 8. As shown, the blade 48 extends from the rotating piece 42 in a direction perpendicular to top 44. A front face 90 of the blade 48 can contact particles 52 during movement of the rotating piece 42.

The blade 48 includes an outer edge 92, which can be substantially flush with an outer edge of the rotating piece 42, or it can be set slightly back from an outer edge, such that blades 48 and 50 cannot be seen when top 44 of rotating piece 42 is viewed. In an embodiment, the outer edge 92 of each blade 48 is the nearest edge of each blade to the outer edge of the rotating piece 42, such that blades 48, 50, etc., are arranged at angles to each other and along various diameters of rotating piece 42 (i.e., with blades angled towards center). In this example, the blades 48, 50 are radially aligned (i.e., angled along lines such as those created by spokes in a bicycle wheel) emanating from a center of the rotating piece 42 towards in all directions towards a circumference). The blade 48 also has inner edge 94 in an embodiment, which can be the edge of the blade 48 closest to an approximate center of the rotating piece 42.

As shown in FIG. 8, the blade 48 can have an opposite edge 96, which is opposite from, and parallel to, the top 44 of the piece 42. The opposite edge 96 faces and is also parallel to the second layer 40, in embodiments. As discussed with respect to FIG. 6, space 60 can exist between the blade 48 and a layer of the card 10, such as the second layer 40. In embodiments, the opposite edge 96 does not have a substantially flat shape, as shown in FIG. 8, but instead has a pointed, rounded, or angled shape.

The blade 48 can be made of weak enough material to provide some give or flexibility if brought into contact with a layer, such as layer 40 or a particle 52. In embodiments, only the tip or outer portion of blade 48 is weaker or thinner, to enable sweeping or rubbing against layer 40 during movement. Blades 48 and 50 can be different thicknesses from each other or, as described above, throughout the length of a blade 48, such that a blade 48 is thinner towards a distal tip of the blade 48 (closer to opposite edge 96). The embodiment in FIG. 8 shows the front face 90 of the blade 48, which can contact particles 52 when moved within the enclosure 18. The blade 50 includes an equivalent second front face 98, which also contacts particles 52 upon clockwise movement of the piece 42 shown in FIG. 8. In an embodiment, when the blade 48 is at the top position or the bottom position among the blades (with respect to a rotating piece 42 that is positioned vertically within card 10), the flat, rectangular side 90 of blade 48 faces outwards, towards either the left and right side of the card 10.

In embodiments, the blades 48 and 50 are made of the same material as the rotating piece 42, which may be any suitable material such as a plastic, metal, or paper/cardboard material. In some cases, the blades 48 and 50 may be made of a different material than piece 42 and are coupled to piece 42. In some cases, the blades 48 and 50 make up the majority of the piece 42, such that most of moving the piece 42 consists of the blades 48, 50 or other portions designed to push or interact with particles. In embodiments, the piece 42 can be one or more blades or push or pull devices.

FIG. 9 shows a perspective view of the rear of the card 10 in an embodiment, where an intermediate panel or back layer 62 of the front panel 12 has been separated from one or more front layers (such as the front layer 14 and the second layer 40), so that three separate layers of the front panel 12 are shown separately on the right-hand-side of FIG. 9 (here, back layer 62, and second layer 40, and front layer 14).

In the embodiment shown in FIG. 9, a back side 100 of the rear panel 16 of the card 10 is shown on the left-hand-side. One or more areas 102 on back side 100 can include a serial number, trademark and/or trademark registration information, a barcode, a logo, pricing, or other information, in embodiments. In the exemplary card 10 in FIG. 9, the back side 100 of the rear panel 16 meets the back layer 62 of the front panel 12 along the crease 26. In embodiments, the back panel 16 is connected to back layer 62, but it is not directly connected to one or more other layers, such as second layer 40 and front layer 14; these other layers can be connected or coupled to, or integral with or extending from, the back layer 62.

Continuing with the embodiment of the card 10 in FIG. 9, the third or back layer 62 of the front panel 12 has a front side 104. In an embodiment, the front side 104 of the back layer 62 is facing towards a viewer of the card 10 when a viewer is viewing the front panel 12 with the card 10 in a substantially closed condition (see FIG. 3). The back layer 62 is shown separated from middle layer 40 in FIG. 9 for illustrative purposes; in embodiments, the middle layer 40 (and the front layer 14 can be sealed or secured to the back layer 62, such that the font panel 12 of the card 10 is formed and a solid layer (back layer 62) conceals one or more components used to cause movement in the enclosure 18. The back layer 62 can be closed or folded upon the layer 40 along a crease 106, such that a back side 108 of the front 14 is facing the front side 104 of back layer 62. The middle layer 40 is a separate panel or piece that is positioned between the back layer 62 and the front layer 14 and is secured on both sides to the one of the back layer 62 or the front layer 14. Alternatively, the card 10 may be formed from a single blank and made to have four connected panels by including three fold line (not shown).

As shown in FIG. 9, this embodiment of the card 10 includes a component 110, which can be part of or connected to the control 30. In embodiments, pressure upon the control 30 causes activation of the component 110, which sends a signal, such as an electrical signal, along a connection 112. In one example, a touch, motion, heat or light sensitive control 30 communicates with the component 110, which can be a sensor of a positive or received sensation electrically or mechanically, and which sends a signal along a wired connection 112. In embodiments, the control 30 provides information, sensations, or access to the component 110, and the component 110 includes a sensor of touch, heat, motion, or light. In the illustrated embodiment, the control is a graphical indication on the front of the front panel 12 that is aligned with a press button that is the component 110.

The connection 112 can be received by a substrate or circuit board 114 or another control or processing mechanism within the card 10. In an example, the substrate 114 includes one or more components such as circuitry and power sources, including circuitry, logic and/or stored instructions pertaining to receiving an indication from the component 110 through the connection 112. In an embodiment, circuitry 116 can include logic regarding receiving signals and transmitting power, such as a pulse or timing information or control abilities. For example, the circuitry 116 can be used to control pulses or intervals of movement, or other permissions or timing related to activating movement, within the enclosure 18, as discussed below.

The circuitry 116 can communicate with one or more power sources 118, 120, which can be batteries or other forms of stored or accessible power, for example. The circuitry 116, in embodiments, can include aspects of a microprocessor and/or chip, such as capacitors, resistors, ports, inputs/outputs, and/or printed or wired connections, and the circuitry 116 can include storage structure, such as memory (including volatile memory, such as flash, and/or non-volatile memory, which can be used in connection with one or more power sources, RAM, ROM, etc.) and instructions for controlling use of power, such as the one or more power sources 118, 120. In embodiments, functions performed by one or more aspects of the circuitry 116 can be controlled or provided by other components within the enclosure 18 or the card 10, or not included as functions of certain embodiments.

The power sources 118, 120 can store or provide electrical power from one or more batteries, or stored solar power from a solar panel (not shown), or stored power from other sources, such as a charge or mechanical work converted to power accessible by the circuitry 116. In embodiments, after operation of the control 30, the component 110 communicates with elements located on, connected to, or coupled with the substrate 114, which cause one or more transmissions over connection 122, as discussed below.

As shown in FIG. 9, the connection 122 connects or couples the substrate 114 through opening 78, which allows connection with the connection 76. In embodiments, connection 122 is continued integrally though the opening 78 in the back side 108 of the second layer 40 to become the connection 76 in the front of the second layer 40, as shown in FIG. 7. In embodiments, other methods of connecting the substrate 114, including the circuitry 116 and the power sources 118, 120, to the motor 70 can be used, such as direct connections or wireless connections. One or more connections can occur directly or indirectly from a component 110 to the motor 70, particularly if a moving element within the enclosure 18 includes one or more of the components shown on the front side 104 in FIG. 9. For example, a moving element, such as the rotating piece 42, can include a power source or circuitry to control timing or behavior of pulses of energy, such that all circuitry and other electrical and mechanical controls and components are substantially within the enclosure 18. In another embodiment, connection 76 and connection 122 are the same connection.

In embodiments, the card 10 or the front panel 12 is part of a product container and/or built into the packaging or container for a product. The card 10 or an embedded front panel 12 in accordance with embodiments is not limited to substantially rectangular panels, such as front panel 12 and rear panel 16. Segments or panels of the card 10 can be any shape, such as heart-shaped, half-heart-shaped (such that the card 10 forms a heart-shape in an open position), square, rounded, etc. In embodiments, one or both panels (e.g., front panel 12 and rear panel 16) can be shaped like a cartoon character, photographed object, or other symbol or object, which may be consistent with an image or message displayed on or in the card 10. In embodiments, part of the card 10, such as a top portion, may be shaped in one manner, such as the shape of the head of a cartoon character, while another portion may be substantially square- or rectangular-shaped, for example.

The card 10 can include additional segments or panels as desired, and the one or more panels (e.g., front panel 12 and rear panel 16) do not have to be the same shape or size. For example, the front panel 12 can be larger or smaller, or shaped differently than the rear panel 16. Additional panels may be added or included, such that the card 10 has a middle or third “page” for purposes of viewing or effect. Multiple panels could be used to convey a book-type or photo-album-type effect, or a middle page could be of another material, such as a thinner material, or a different color of material, or a transparent material, to add effect(s) to the card 10.

In embodiments, a tri-panel or multi-panel card 10 (when assembled) has one panel, such as front panel 12, that includes multiple layers and an enclosure 18, along with control 30. Alternatively, an internal panel or rear panel 16 can comprise one or more layers and include the enclosure 18, with an internally-located control (not shown), such that a user opens card 10 in order to view enclosure 18. An internal layer, such as middle layer 40, can be a smaller size than one or more other layers, in some cases to embed the second layer 40 within a panel (e.g., front panel 12) of the card 10. In one example, sides or edges or one or more layers, such as the front layer 14, can be folded or creased for smoothness, thickness, and/or to wrap around or contain a smaller middle layer, such as second layer 40.

In an example, the enclosure 18 is integral with the second layer 40, and the cover 20 is integral with the first layer 14. In another embodiment, layers are connected at one or more edges, integrally or through another method of connection, such as adhesive, while the enclosure is of another material and affixed to a layer, such as to second layer 40. The front layer 14 may be the only layer of the front panel 12, with additional material used on the inside of card 10 to conceal any components that would otherwise be exposed, such as connections to a control 30 and/or a power source 118, if these components are not within the enclosure 18 and/or in front of the front layer 14. In embodiments, one or more panels of the card 10 are water-proofed (through a separate process or layer, or through construction of spaces with contained or enclosed components) and/or enclosed in a water-proof covering or packaging for purposes of mailing or other delivery steps.

In embodiments, the particles 52 can be of various sizes or of uniform size, and the pieces of matter can have an approximate or average mass relative to the power of one or more moving components and/or the desired dispersion. In embodiments, pulses or the timing of movement is provided to reinforce or cause feedback or additional interactions among particles 52 and/or moving components. In an embodiment, a first movement, such as a spin or rotations, disperses particles initially and a second or later movement, rotation, or pulse causes particles 52 to interact or interact further. The particles 52 can be grains or grain-shaped or pellets in any amount or shape that fits inside enclosure 18. In embodiments, the particles 52 are to look like or behave like snowflakes, such as flakes found in snow globes. The particles 52 can include candy, or candy-looking pieces, glitter, confetti, raindrops, or small plastic or other lightweight symbols or shapes, such as planes or stars. The weight or mass of the particles 52 can be considered, along with any friction between the particles 52 or static electricity behavior related to the enclosure 18.

The card 10, in accordance with embodiments of the invention, can include one particle (such as a component of a game, for example a pinball). In an embodiment, the rotating piece 42 could enable or trigger the playing of a game, such as a simulated version of any game involving a “spin” or propel-type function, such as roulette or pinball, such that a viewer of the card 10 can play, or simulate playing, a game, and a goal of the game can be to place one or more particles in a particular place or fashion. The enclosure 18 and the moving components, such as the rotating piece 42 or other forward-moving or air-moving components, can facilitate functions such as blowing bubbles or another substance (e.g., creating a fog effect, fragrance, or accompanying sound).

In an example, the rotating piece 42 can be a decorated fan or wheel if exposed or partially-exposed and/or if the rotating piece 42 is part of a theme of the card 10. An asymmetrical, biased and/or weighted moving element, such as the rotating piece 42, can be used in embodiments and can achieve visual effects such as erratic rotation and/or dispersion of particles 52. In embodiments, portions of the rotating piece 42 are visible in the enclosure 18, so that an enclosure could be affixed in a manner that allows viewing of a photograph or graphic image of a boat or helicopter, and the rotating piece 42 could be visible and placed to be or emulate a propeller on the boat or blades on the helicopter. In an embodiment, a background for clock hands or a windmill appears on the second layer 40 behind the enclosure 18, and the rotating piece 42 is at least partially visible and corresponds with the background.

The card 10, in embodiments, can employ a motion, touch or other sensor to activate movement, in embodiments, and pre-programmed or pre-set computerized or mechanical mechanisms can be used, such as the circuitry 116, to time intervals or pulses of movement. In embodiments, transmissions along the connection 122 to the motor 70 can include regular or irregular pulses at predetermined time intervals. In some cases, one or more bursts or pulses of energy sent to moving components, such as the rotating piece 42 or a forward push-type mechanism, can be used or optimized to cause the most interaction among particles 52.

With reference to FIG. 4, a clockwise movement of the rotating piece 42 can cause an initial flow of particles in a clockwise direction and in a plane along the front layer 14 and the front panel 12 (parallel to the plane of view) and substantially along outer portions of the enclosure 18. The particles 52 can be caused to interact more with walls or sides of the enclosure 18 due to a path or flow of particles that includes the elongated end 80 in conjunction with a non-elongated (i.e., more rounded) top end. In embodiments, the space 54 assists with the timing of a flow of particles 52 and pulses of movement. In some cases, a second movement or pulse (and other additional movements or pulses after an initial pulse) causes more interaction among particles 52, which can be partly due to the amount of time between pulses.

In one example, a second pulse causes particles 52 to flow around or within the enclosure 18 in a manner that increases the interactions or collisions among other particles 52, such as those dispersed with an initial pulse. The rotating component 42 can be placed at specific distances from the edges or outer sides of the encapsulated area that are substantially perpendicular to the front panel 12 of card 10, based on the size or weight of particles 52, for example, in order to facilitate the flow of the particles 52, where a flow can include intentional disruption of a circular or smoother flow in favor of disbursement or maximum collisions or mixing among particles 52.

Various components or features of embodiments of card 10 can be made integral with each other, including any and all layers of the front panel 12 and/or the enclosure 18. Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

1. A greeting card comprising:
a panel comprising at least two layers, including a first layer and a second layer;
an enclosure coupled to the second layer, wherein a portion of the enclosure is located between the first layer and the second layer;
a set of particles located within the enclosure; and
a moving element in fluid communication with the enclosure, wherein activation of the moving element moves at least a portion of the particles within the enclosure.

2. The greeting card of claim 1, wherein the moving element is connected to a power source.

3. The greeting card of claim 1, wherein the moving element includes one or more blades.

4. The greeting card of claim 3, wherein the moving element rotates about an axis, and wherein the one or more blades extend from the moving element in a direction substantially parallel to the axis.

5. The greeting card of claim 1, wherein the moving element is at least partially contained within the enclosure and wherein a space separates the moving element from an edge of the enclosure.

6. The greeting card of claim 5, wherein a size of the space varies along the edge of the enclosure.

7. The greeting card of claim 1, wherein a cover extends from the first layer, wherein the cover extends over a portion of the enclosure.

8. A card comprising:
a first segment and a second segment, wherein the first segment includes a front side and back side;
an encapsulated area affixed to the first segment and extending from the front side, wherein the encapsulated area includes a bulged portion;
a rotating piece positional in the encapsulated area and capable of rotational movement, wherein the bulged portion substantially surrounds the rotating piece in a first plane that is parallel to the front of the greeting card; and
a cover, extending from the first segment, wherein the cover extends over a portion of the enclosure, such that the cover extends over a portion of the rotating piece.

9. The greeting card of claim 7 further comprising: multiple pieces of matter located in the encapsulated area and movable therein, wherein the multiple pieces of matter interact with the rotating piece.

10. The greeting card of claim 7 further comprising: a control coupled to the rotating piece and configured for activation thereof.

11. The greeting card of claim 7 further comprising an electric motor with an axle extending therefrom, wherein the rotating piece includes a generally circular and planar top connected to the axle and perpendicular thereto, wherein a plurality of blades extend perpendicularly from a surface of the top facing the motor, wherein the blades are on a same side of the top as the axle, wherein the blades are spaced apart from the axle, and wherein at least a portion of the blades extend around the motor and rotate there about during operation.

12. (canceled)

13. The greeting card of claim 7, wherein the rotating piece is configured to receive two or more pulses of energy, wherein a predetermined amount of time exists between the two or more pulses.

14. A note comprising:
a front panel and a back panel, wherein said front panel and said back panel are substantially stacked when the note is in a closed condition;
a sealed space coupled to said front panel, wherein a portion of said sealed space comprises an elongated end;
a covering coupled to said front panel, wherein said covering partially covers a portion of said sealed space, such that said covering covers said elongated end; and
a rotating element contained within said sealed space and located substantially within said elongated end of said sealed space.

15. The note of claim 14, wherein said note is a greeting card.

16. The note of claim 14, wherein use of a control causes activation of said rotating element.

17. The note of claim 16, wherein said activation of said rotating element includes two or more pulses of movement.

18. The note of claim 17 further comprising: two or more blades coupled to said rotating element.

19. The note of claim 18, wherein said rotating element rotates in a plane perpendicular to an axis, wherein said two or more blades are substantially parallel to said axis and are spaced apart therefrom, and wherein said blades rotate about said axis during operation.

20. The note of claim 19 further comprising: a set of particles within said sealed space, wherein said set of particles is partially propelled about the sealed space by said two or more blades.
